(19) United States
(12) Patent Application Publication
(10) Pub. No.: US 2025/0092778 A1
(43) Pub. Date: Mar. 20, 2025

(54) SYSTEM AND METHODS FOR DISTANCE DETERMINATION WITHIN A BOREHOLE

(71) Applicant: Quaise Energy, Inc., Cambridge, MA (US)

(72) Inventors: Hin Y. Lee, Pearland, TX (US); Richard Meehan, Houston, TX (US)

(21) Appl. No.: 18/813,784

(22) Filed: Aug. 23, 2024

Related U.S. Application Data
(60) Provisional application No. 63/539,541, filed on Sep. 20, 2023.

(51) Int. Cl. E21B 47/04; G01S 13/32; G01S 15/32

(52) U.S. Cl. CPC E21B 47/04; G01S 13/32; G01S 15/32

(57) ABSTRACT

Systems and method are provided herein for performing MMWD using a gyrotron to provide electromagnetic waves into a borehole via a waveguide during borehole formation. Borehole depth and a distance between the waveguide and the bottom of the borehole can be determined using radar or acoustic signal processing techniques. The radar and acoustic signal sources can be configured to transmit measurement signals into the waveguide simultaneously with the electromagnetic waves transmitted by the gyrotron thereby eliminating the need for downhole sensing equipment and eliminating the need for drilling operation downtime to perform diagnostic depth measurements.

### CROSS-REFERENCE TO RELATED APPLICATIONS

This application claims the benefit of U.S. Provisional Application No. 63/539,541, filed on Sep. 20, 2023, entitled “System and Methods For Distance Determination Within A Borehole,” the entirety of which is incorporated by reference herein.

### TECHNICAL FIELD

The subject matter described herein relates to drilling in sub-surface geologic formations using conventional drilling and non-conventional drilling techniques such as millimeter wave drilling, thermal drilling, and the like.

### BACKGROUND

Conventional and non-conventional drilling utilize a drilling apparatus to form a borehole into a sub-surface geologic formation. As the drilling apparatus forms the borehole to a borehole depth, the apparatus is brought into contact with or is in proximity of the bottom of the borehole. Monitoring borehole depth can be an important parameter to consider in order to perform drilling operations efficiently.

### SUMMARY

In one aspect, a method for determining borehole distances is provided. In one embodiment, the method can include receiving, by a data processor, first data characterizing a first radar signal reflected at a first frequency from a bottom of a borehole. The method can also include receiving, by the data processor, second data characterizing a second radar signal reflected from a waveguide within the borehole. The method can further include determining, by the data processor, a distance between the waveguide and the bottom of the borehole based on a time of flight difference between the first radar signal and the second radar signal and providing, by the data processor, the distance.

In some embodiments, the first radar signal can be reflected responsive to transmitting a third radar signal into the waveguide from a FMCW radar coupled to the waveguide. In some embodiments, the third radar signal can be transmitted coincident with an electromagnetic wave transmitted into the waveguide by a gyrotron coupled to the waveguide. In some embodiments, the electromagnetic wave can be transmitted into the waveguide in HE11 transmission mode. In some embodiments, the second radar signal can be measured as a beat frequency difference between the third radar signal and the second radar signal. In some embodiments, the distance can be measured between the bottom of the borehole and a terminal end of the waveguide. In some embodiments, the distance can be a standoff distance.

In another aspect, a method for determining borehole distances is provided. In one embodiment, the method can include receiving, by a data processor, first data characterizing a first acoustic signal corresponding to a first impedance change reflected from a waveguide inserted into a borehole. The method can also include receiving, by the data processor, second data characterizing a second acoustic signal corresponding to a second impedance change reflected from a bottom of the borehole. The method can further include determining, based on the data processor, a distance between the waveguide and the bottom of the borehole based on a time of flight difference between the first acoustic signal and the second acoustic signal, and providing, by the data processor, the distance.

In some embodiments, the first impedance change can be reflected responsive to transmitting an acoustic pressure signal into the waveguide via a gas supply unit coupled to the waveguide, the gas supply unit configured to supply the acoustic pressure signal into the waveguide. In some embodiments, the first data and the second data can be received by at least one pressure sensor positioned on the waveguide and communicably coupled to the data processor. In some embodiments, the at least one pressure sensor can include a high frequency pressure sensor. In some embodiments, determining the distance can further comprise determining a first velocity of the first acoustic signal and a second velocity of the second acoustic signal. In some embodiments, the distance can be determined using at least one of tapped delay filter line estimation techniques or frequency modulated continuous wave processing techniques.

In another aspect, a system for determining borehole distances is provided. In one embodiment, the system can include a waveguide positioned within a borehole. The system can also include a gyrotron coupled to the waveguide and configured to transmit electromagnetic waves into the borehole via the waveguide. The system can further include a radar source coupled to the waveguide and configured to transmit radar signals into the borehole via the waveguide. The system can also include at least one computing device communicably coupled to the radar source. The at least one computing device can include a data processor and a memory storing non-transitory instructions, which when executed by the data processor, can cause the data processor to perform operations including receiving first data characterizing a first radar signal reflected at a first frequency from a bottom of the borehole. The operations can also include receiving second data characterizing a second radar signal reflected from the waveguide within the borehole. The operations can further include determining a distance between the waveguide and the bottom of the borehole based on a time of flight difference between the first radar signal and the second radar signal, and providing, by the data processor, the distance.

In some embodiments, the radar source can be a frequency modulated continuous wave radar. In some embodiment, the radar source can be coupled to the waveguide by at least one of a transmission mode converter or a diffraction grating mirror configured to maintain provision of the transmitted radar signals as frequency modulated continuous wave radar signals. In some embodiments, the first radar signal can be reflected responsive to the radar source transmitting a third radar signal into the waveguide. In some embodiments, the third radar signal can be transmitted coincident with an electromagnetic wave transmitted into the waveguide by the gyrotron. In some embodiments, the electromagnetic wave can be transmitted into the waveguide in HE11 transmission mode. In some embodiments, the waveguide can include a plurality of corrugation features arranged on an inner surface of the waveguide. The plurality of corrugation features can be configured to maintain transmission of the electromagnetic wave through the waveguide and into the borehole in the HE11 transmission mode. In some embodiments, the second radar signal can be measured as a beat frequency difference between the third radar signal and the second radar signal.

In another aspect, a system for determining borehole distances is provided. In an embodiment, the system can include a waveguide positioned within a borehole and including at least one pressure sensor arranged on the waveguide. The system can also include a gyrotron coupled to the waveguide and configured to transmit electromagnetic waves into the borehole via the waveguide. The system can further include a gas supply unit coupled to the waveguide and configured to transmit acoustic signals via a gas into the borehole via the waveguide. The system can also include at least one computing device communicably coupled to the at least one pressure sensor and the gas supply unit. The at least one computing device can include a data processor and a memory storing non-transitory instructions, which when executed by the data processor, can cause the data processor to perform operations including receiving first data characterizing a first acoustic signal corresponding to a first impedance change reflected from a waveguide inserted into a borehole. The operations can also include receiving second data characterizing a second acoustic signal corresponding to a second impedance change reflected from a bottom of the borehole. The operations can also include determining a distance between the waveguide and the bottom of the borehole based on a time of flight difference between the first acoustic signal and the second acoustic signal, and providing the distance.

In some embodiments, the first impedance change can be reflected responsive to transmitting an acoustic pressure signal into the waveguide via the gas supply unit. In some embodiments, the first data and the second data can be received by the at least one pressure sensor. In some embodiments, the at least one pressure sensor can include a high frequency pressure sensor. In some embodiments, determining the distance can further include determining a first velocity of the first acoustic signal and a second velocity of the second acoustic signal. In some embodiments, the distance can be determined using at least one of tapped delay filter line estimation techniques or frequency modulated continuous wave processing techniques.

### DESCRIPTION OF DRAWINGS

These and other features will be more readily understood from the following detailed description taken in conjunction with the accompanying drawings, in which:

FIG. 1 is a system diagram illustrating one exemplary embodiment of a system for determining borehole distances using radar and/or acoustic pressure signals according to methods described herein;

FIG. 2 is a diagram illustrating a cross sectional view of a borehole including a waveguide configured for MMWD included in the system of FIG. 1;

FIG. 3 is an exemplary block diagram of a circuit configured to determine borehole distances using radar signals as described herein;

FIG. 4A is a heatmap plot illustrating amplitude vs. beat frequencies for experiments varying the distance of a radar source from a target using the circuit of FIG. 3;

FIG. 4B is a plot illustrating amplitude vs. beat frequency spectrum for experiments varying the distance of a radar source from a target using the circuit of FIG. 3;

FIG. 5 is a plot of distance vs. peak beat frequency for experiments varying the distance of a radar source from a target using the circuit of FIG. 3;

FIG. 6 is a heatmap plot illustrating reflection trends originating from a radar source for which distance to a target has been varied using the circuit of FIG. 3;

FIG. 7 is a block diagram of an embodiment of the system of FIG. 1 configured to use acoustic pressure signals for determining borehole distances according to methods described herein;

FIG. 8 illustrates an example embodiment for determining reflected and transmitted impulses from an initial impulse of acoustic pressure using the embodiment of FIG. 7;

FIG. 9 is a wavefield plot illustrating amplitudes of acoustic pressure signals provided relative to pressure sensor location on the waveguide of the embodiment of FIG. 7;

FIG. 10 is a plot illustrating correlation time of an acoustic pressure signal as a function of elapsed time for acoustic signal processing using the embodiment of FIG. 7; and

FIG. 11 is a plot illustrating distances of an acoustic pressure signal reflecting from reflective elements included in the embodiments of FIG. 7; and

FIG. 12 is a block diagram of an exemplary computing system configured for use in the system of FIG. 1.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Conventional drilling can be used to form boreholes of wells in order to access natural resources, which may be present within sub-surface geologic formations surrounding or close to the borehole. Conventional drilling can include rotary drilling, hammer drilling, and/or a combination of rotary drilling and hammer drilling. Conventional drilling can employ liquids, such as mud or water, and/or gases, such as air or foam, for cleaning and cooling during drilling. Conventional drilling can be employed to form boreholes within soft, porous rock and can include the use of rotating drill bits, such as polycrystalline diamond bits, roller cones, and high-pressure liquid jets. Conventional drilling can utilize rotating drilling apparatuses to cut or grind rock during the formation of the borehole. The cut or ground rock can be removed via a fluid provided into the borehole to lift the cut or ground material from the borehole. Conventional drilling can achieve limited and lower rates of penetration at deeper borehole depths due to increasing temperatures and increasing hardness of the rock present at deeper borehole depths. The ability to transmit power from the surface to the bottom of the borehole can also limit the rate of penetration achieved using conventional drilling in deep boreholes.

Thermal drilling, such as Millimeter Wave Drilling (MMWD) can utilize a waveguide apparatus to achieve greater rates of penetration. The waveguide apparatus can conduct large amounts of radiative energy into the borehole in combination with gas at pressure to melt or vaporize rock. MMWD can be advantageous compared to conventional drilling because rock is melted and vaporized into very small particles and removing the mixture of rock and vapor is easier than in conventional drilling. Higher rates of penetration can be achieved using MMWD compared to conventional drilling because the abundance of applied thermal energy at the terminal end (or at a launcher) of the waveguide is more effective at penetrating rock over long distances compared to rotating mechanical action of a drill bit at the terminal end of a conventional drilling apparatus. The terminal end of the waveguide is the end of the waveguide that is closest to the bottom of the borehole. Thus, MMWD can be beneficial forming deeper wells in order to access natural resources or hot dry rock, which can be present at greater depths below the surface.

Maintaining a consistently formed borehole can be accomplished by monitoring a depth of a borehole and a standoff distance. In MMWD, the standoff distance can be an amount of distance between the bottom of the borehole and a reference point configured in the waveguide at a known distance from the terminal end of the waveguide apparatus. The standoff distance can be important as it can have an impact on the hole diameter being generated. It is advantageous to form a borehole having a uniform diameter. Determining and maintaining the correct standoff distance can improve methods of forming a borehole with a uniform diameter.

MMWD can involve using multiple sections of waveguide that are inserted into a borehole as the borehole is formed to greater depths by electromagnetic waves generated by a gyrotron at the surface in proximity of the borehole. As the electromagnetic waves melt/vaporize the rock at the bottom of the borehole, the borehole deepens and additional waveguides are inserted into the borehole to continue drilling to greater depths. The rate at which rock melts can be affected by the proximity of the electromagnetic waves exiting an end of the waveguide to the rock at the bottom of the borehole. Thus, maintaining the waveguide at a distance relative to the bottom of the borehole can be important to ensure proper borehole formation but also to protect the waveguide from contacting the rock at the bottom of the borehole, which can cause damage to the waveguide. The hot thermal properties within the borehole can make it difficult to infer borehole depth based on the length of the inserted waveguide because the waveguide can undergo thermal expansion. The hot downhole conditions can also reduce the use of wired sensors placed into the borehole, because the sensors are not likely to withstand the elevated temperatures within the borehole. The elevated temperatures within the borehole make downhole sensors likely to fail under the extreme temperature conditions. Thus, determining ranges or distances within a borehole during MMWD can be challenging.

The systems and methods herein can address these issues by utilizing radar and/or acoustic signals generated at the surface and provided into the borehole via the waveguide to determine a depth of a borehole and a standoff distance. The radar and/or acoustic signals can be provided into the waveguide as the gyrotron is providing electromagnetic waves for drilling the borehole deeper. The radar and/or acoustic signals that reflect back from within the borehole can be processed by computing devices to determine the borehole depth and standoff distance. By placing the radar and/or acoustic signal generating devices at the surface, there is less likelihood for failure of sensors placed within the borehole. Additionally, the systems and methods herein allow for depth and standoff distance measurements using the same waveguide utilized for MMWD, thus there is no need for separate diagnostic equipment and no need to temporarily stop drilling operations for measurements of borehole depth and standoff distance, which can increase the efficiency of the MMWD.

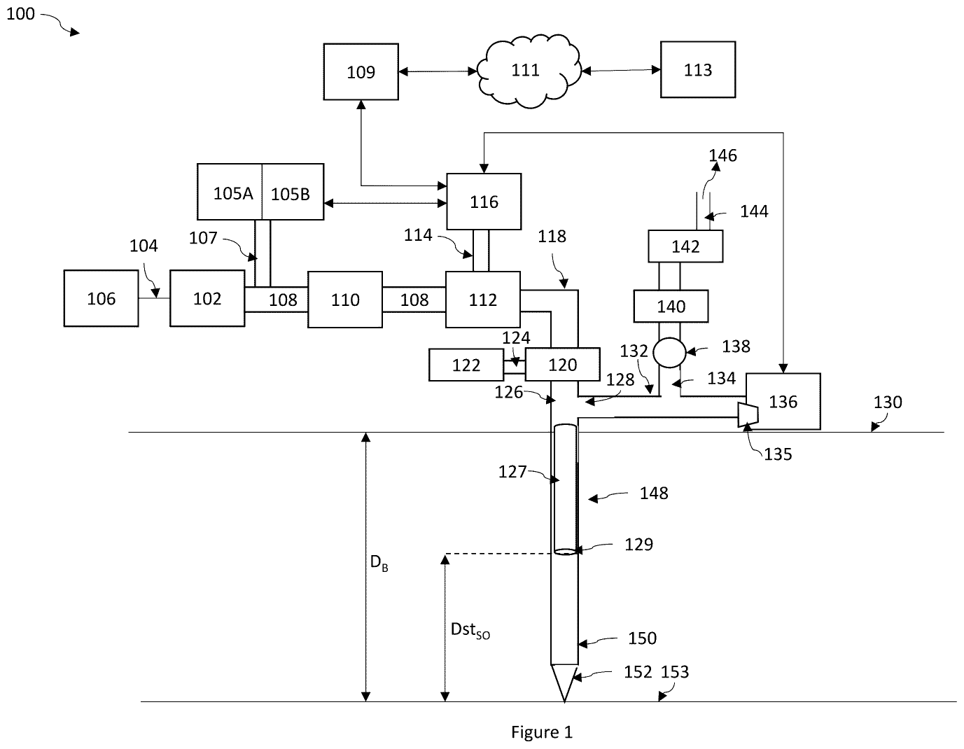

FIG. 1 is a diagram illustrating an exemplary embodiment of a MMWD system 100 for determining a borehole depth (D_{B}) and standoff distance (Dst_{SO}) within a borehole 148 using radar-based and acoustic-based sensing methods as will be described herein. The system 100 can include a MMWD apparatus configured as described in U.S. Pat. No. 8,393,410 to Woskov et. al, entitled “Millimeter-wave Drilling System,” the entirety of which is incorporated by reference herein. The MMWD system 100 shown in FIG. 1 includes a gyrotron 102 connected via power cable 104 to a power supply 106 supplying power to the gyrotron 102. The high-power millimeter wave beam output by the gyrotron 102 is guided by a waveguide 108 which has a waveguide bend 118, a window 120, a waveguide section 126 with opening 128 for off gas emission and pressure control. In some embodiments, the window 120 can be a polytetrafluoroethylene window. In some embodiments, the window 120 can be a diamond window. Sections 127 of the waveguide can be configured below the surface 130 to help seal the borehole. Additional waveguide sections 127 can be inserted into the borehole as drilling progresses deeper below the surface 130.

The system 100 also includes a frequency-modulated continuous wave radar (FMCWR) 105. FMCW (frequency-modulated continuous wave) radar is a radar in which the transmitted electromagnetic radar signal is modulated in frequency. The FMWCR 105 can be configured to generate electromagnetic waves at particular frequencies based on the required accuracy, waveguide geometry, and the need to avoid frequencies that are close to those of the electromagnetic wave emitted by the gyroton 102. In some embodiments, the FMWCR 105 can be configured to generate electromagnetic waves at frequencies between about 125-129 GHz. The FMWCR 105 can also be configured to measure reflections from portions of the waveguide sections 127 and/or the bottom of the borehole 152. The FMCWR 105 can include a transmitter portion 105A configured to convey electromagnetic radar signals and a receiver or detector portion 105B configured to detect or receive reflected electromagnetic radar signals. The configuration of the FMCWR 105 can be arranged with respect to other aspects of the MMWD system 100, such as a geometry of the waveguides 108, 118, 126, and 127, a frequency of the gryrotron 102, and a physical location of other components of the system 100, such as window 120, diagnostic access 112, and digital acquisition unit 116. For example, the frequency of the electromagnetic waves generated by the FMCWR 105 needs to be separated from the frequency of the electromagnetic waves generated by the gyrotron 102. In some embodiments, the gyrotron 102 can emit electromagnetic waves at about 95-105 GHz. Thus, having at least a 10 GHz difference between the electromagnetic waves generated by the gyrotron 102 and those generated by the FMCWR 105, several techniques can be utilized to filter out the frequency emitted by the gyrotron 102 from the frequencies emitted by the to the FMCWR 105 and prevent damage to the electronics of the system 100. In some embodiments, a small cut off hole filter or diffraction grading can be used to separate the frequencies associated with the gyrotron 102 and the FMCWR 105. Secondly, there is consideration to minimize signal attenuation by atmospheric constituents such as oxygen and water. To avoid the absorption bands for oxygen and water around 120 GHz, the FMCWR 105 would operate in about the 125-129 GHz range.

The FMCWR 105 can be coupled to the waveguide 108 via a couple 107. The coupling 107 can be configured to introduce the electromagnetic waves of the FMCWR 105 into the waveguide 108 in the transmission mode associated with the gyrotron 102, e.g., in HE11 transmission mode. In some embodiments, the system 100 can also include a mode converter, a coupling plate/mirror with different designs at different positions of the waveguide 108 to minimize the attenuation and allow the electromagnetic waves associated with the gyrotron 102 and the FMCWR 105 to be transmitted through the waveguides 108, 118, 126, and 127 into the borehole 148. The FMCWR 105 can be communicably coupled to the DAU 116, described below, to convey FMCWR signal data to the DAU 116 for use in determining borehole depth (DB) and standoff distance (DstSO) using the FMCWR signal data. Additional details describing methods of determining the borehole depth (DB) and standoff distance (DstSO) using FMCWR signal data will be described in more detail later.

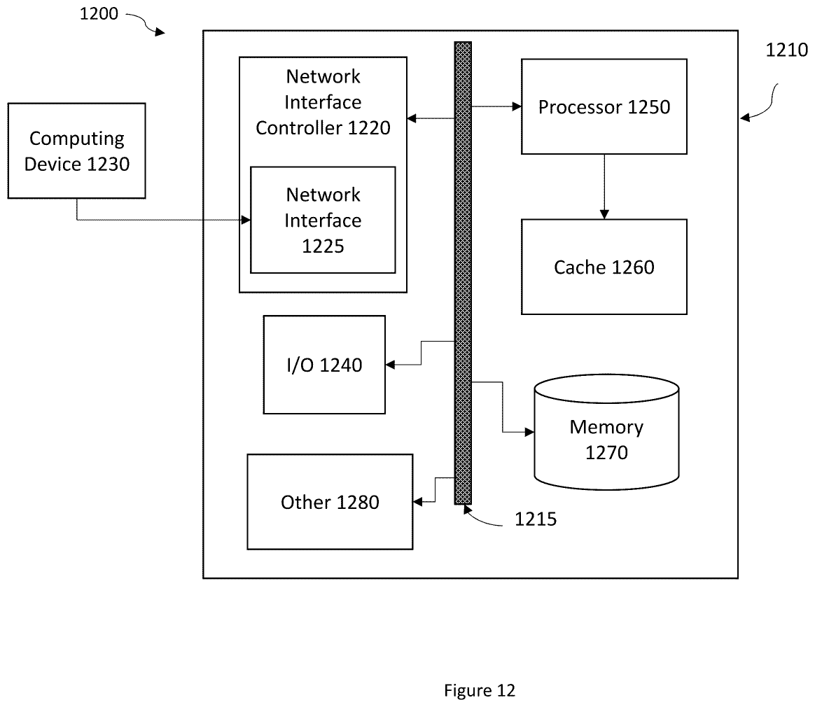

As part of the waveguide transmission line 108 there is an isolator 110 to prevent reflected power from returning to the gyrotron 102 and an interface for diagnostic access 112. The diagnostic access 112 is connected to a diagnostics electronics and data acquisition unit (DAU) 116 by a low power waveguide 114 The DAU 116 can be communicably coupled a computing device 109, which can be coupled to another computing device 113, such as a server device or a database, via a network 111. The DAU 116, and computing devices 109 and 113 can be configured as described later in relation to FIG. 12.

At the window 120 there is a pressurized gas supply unit 122 connected by plumbing 124 to the window to inject a clean gas flow across the inside window surface to prevent window deposits. A second pressurization unit (SPU) 136 is connected by plumbing 132 to the waveguide opening 128 to help control the pressure in the borehole 148 and to introduce and remove borehole gases as needed. The SPU 136 can also be configured to generate an acoustic pressure signal in the gas that flows into the waveguides 126, 127. This signal travels through the gas and reflects from impedance changes caused by features at the terminal end of the waveguide section 127 and/or the bottom 153 of the borehole 148. In some embodiments, one or more sensors 135 can be configured on portions of the waveguide 127 in addition or alternatively from that configured at the SPU 136. The sensors 135 can be communicatively coupled to the DAU 116 to convey acoustic pressure signal data for determination of borehole depth (D_{B}) and standoff distance (Dst_{SO}).

In some embodiments, a launcher 129 can be configured at the terminal end of the waveguide 127 and can include flange-like structures or radially protruding elements that can reflect electromagnetic waves. In some embodiments, the launcher 129 can include a washer with an opening therein to allow the radar signals to pass through the terminal end of the waveguide 127, reflect from the bottom 153 of the borehole 148, reflect again from the washer at terminal end of the waveguide 127 before reflecting from the bottom 152 of the borehole 148 again and being received at the detector portion 105B of the FMCWR 105.

By recording the reflected signal using a pressure sensor 135 it is possible to determine the distance from the sensor 135 to the features at the terminal end of the waveguide section 127 and/or the bottom 153 of the borehole 148. The SPU 136 can be communicably coupled to the DAU 116 to convey pressure signal data to the DAU 116 for use in determining borehole depth (D_{B}) and standoff distance (Dst_{SO}) using acoustic pressure signal data. Additional details describing methods of determining the borehole depth (D_{B}) and standoff distance (Dst_{SO}) using acoustic pressure signal data will be described in more detail later.

The pressurized gas supply unit 122 at the window 120 is operated at slightly higher pressure relative to the SPU 136 to maintain a gas flow across the surface of the window 120. A branch line 134 in the borehole pressurization plumbing 132 is connected to a pressure relief valve 138 to allow exhaust of volatized borehole material and window gas through a gas analysis monitoring unit 140 followed by a gas filter 142 and exhaust duct 144 into the atmosphere 146. In an alternative embodiment, the exhaust duct 144 returns the gas to the SPU 136 for reuse.

Pressure in the borehole is increased in part or in whole by the partial volatilization of the subsurface material being melted. A thermal melt front 152 at the end of the borehole 148 is propagated into the subsurface strata under the combined action of the millimeter wave power and gas pressure leaving behind a glassy/ceramic borehole wall 150. This wall acts as a dielectric waveguide to transmit the millimeter wave beam to the thermal front 152.

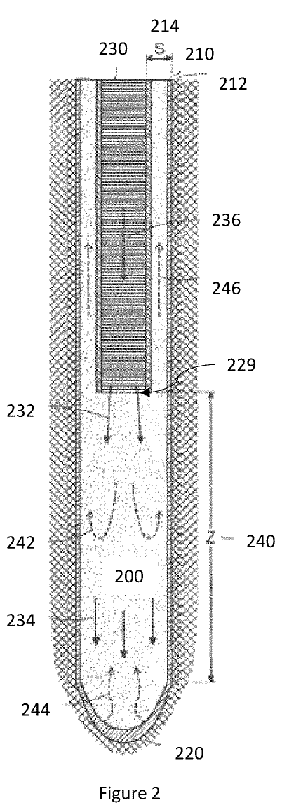

FIG. 2 is a diagram illustrating a more detailed view of a waveguide included the system 100 and provided within a borehole. The borehole 200 with glassy/ceramic wall 210 and permeated glass 212 has a waveguide section 230 inserted therein to improve the efficiency of gyrotron 102 beam propagation. The waveguide section 230 can correspond to the waveguide section 127 described in relation to FIG. 1. In some embodiments, the waveguides 108, 118, 126, 127, and thus 230 can include a plurality of corrugation features arranged on an inner surface of the waveguide that are configured to maintain transmission of the electromagnetic waves through the waveguide in HE11 model. In some embodiments, the waveguide section 230 can include a launcher 229 corresponding to the launcher 129 of waveguide 127 described in relation to FIG. 1.

The inserted waveguide diameter is smaller than the borehole diameter to create an annular gap 214 for exhaust/extraction. The standoff distance 240 (Dst_{SO}) of the leading edge of inserted waveguide 230 from the bottom of the borehole at the thermal melt front 220 is far enough to allow the launched millimeter wave beam divergence 232 to fill 234 the dielectric borehole 200 with the guided millimeter-wave beam. The standoff distance 240 is also far enough to keep the temperature at the metallic insert low enough for survivability. The inserted millimeter-wave waveguide 230 also acts as a conduit for a pressurized gas flow 236 from the surface. This gas flow keeps the waveguide clean and contributes to the extraction/displacement of the rock material from the borehole. The gas flow from the surface 236 mixes 242 with the volatilized out gassing of the rock material 244 to carry the condensing rock vapor to the surface through annular space 214. The exhaust gas flow 246 is sufficiently large to limit the size of the volatilized rock fine particulates and to carry them all the way to the surface.

In view of the foregoing system 100, methods are provided herein for determining the borehole depth (D_{B}) and the standoff distance (Dst_{SO}) using FMCWR signal techniques and acoustic pressure signal techniques.

In broad terms, the transmitter portion 105A of the FMCWR 105 can convey electromagnetic radar signals to the bottom 153 of the borehole 148 using the same waveguide section 127 used by the gyrotron 102 to convey electromagnetic waves in HE11 transmission mode when performing MMWD. Only after the FM radar signals leave the terminal end of the waveguide 127 does it launch into free space before hitting the bottom of the hole and reflecting back to the detector portion 105B of the FMCWR 105 at the surface 130. This propagation to the bottom of the hole and reflection back informs the depth of the borehole (D_{B}). It is also advantageous to determine the standoff distance (Dst_{SO}), which is a critical factor for efficiently performing MMWD operations. The standoff distance (Dst_{SO}) can be obtained by making use of additional reflections. The delay between the reflections can allow the standoff distance (Dst_{SO}) to be determined. FMCW radar can be used to determine distance and standoff measurements because it is suitable for use at extreme depths, such as 20 Km or more below the surface 130, and extreme temperatures of 500 C or higher. No additional equipment is required to go into the borehole 148 besides the equipment already being used for MMWD. As a result, additional electronics are not required to go into the borehole 148, which can often limit the use or installation of depth sensors due to the signal losses that can occur along the length of long cables. Use of FMCWR also avoids issues associated with elevated temperatures, enabling MMWD to be performed more easily in deep, hot environments.

As described earlier, the frequency of the signals transmitted by the FMCWR 105 needs to be separated from the frequency of the electromagnetic waves transmitted by the gyrotron 102 used for MMWD. Using a frequency between about 95 and 105 GHz for the electromagnetic waves emitted by the gyrotron 102, the radar signals emitted from the FMCWR 105 can be configured to be about 10 GHz above the frequency of the electromagnetic waves emitted by the gyrotron 102, although use of other frequencies can be envisioned. The frequency of the radar signals emitted by the FMCWR 105 can be configured based on the frequency of the electromagnetic waves emitted by the gyrotron 102, the geometry of the waveguides 108, 118, 126, 127, as well as the arrangement of features configured at the launcher 129.

To filter the electromagnetic waves emitted from the gyrotron 102 from those associated with the FMCWR 105, a small cut off hole filter or diffraction grading can be used to filter out electromagnetic waves from the gyrotron 102 with response to radar signals associated with the FMCWR 105. Additionally, it can be important to consider and minimize signal attenuation by atmospheric constituents, such as oxygen and water. To avoid the absorption bands for oxygen and water which occur around 120 GHz, it can be advantageous to operate the FMCWR 105 at or around 125-129 GHz. Lastly, as radar signals from the FMCWR 105 would need to be transmitted by the same waveguide where the gyrotron 102 is transmitting, e.g., waveguides 108, 118, 126, and 127, frequency of the radar signals transmitted by the FMCWR 105 needs to be close to the frequency of the electromagnetic waves emitted by the gyrotron 102 in order to share the same waveguide 108, 118, 126, and 127 and to minimize the attenuation therein.

Additionally, the FMCWR 105 can be coupled to the waveguide 108 to maintain MMW transmission and propagation in specific EM modes, such as TE01 and HE11 modes at frequencies between about 95 and 105 GHz. The coupling 107 shown in FIG. 1 can direct and introduce the FMCWR signals from the FMCWR transmitter 105A into the waveguide 108 in the appropriate EM transmission mode. In some embodiments, the system 100 can include a mode converter, a coupling plate, or a diffraction grating mirror with different designs at different positions along the length of the coupling 107 to minimize the attenuation and to allow electromagnetic waves from both the gyrotron 102 and the FMCWR 105 transmitted in the same waveguide 108, 118, 126, and 127.

In some embodiments, a reflecting reference can be configured close to a launcher 129 of a waveguide 127 (or launcher 229 of waveguide 230). Waveguide launchers are mounting points for gyrotrons and can serve to couple the microwave energy from the gyrotron into the system of waveguides. Launchers match the gyrotron's mechanical dimensions and provide the required voltage standing wave ratio (VSWR) and phase for efficient operation of the gyrotron. For example, the reflecting reference can include an iris with an opening therein. In some embodiments, the reflecting reference can include different corrugation patterns along the inner diameter of the waveguide 127. The corrugation pattern can include grooves with a different depth than other grooves within the waveguide 127. In some embodiments, the reflecting reference can be configured to generate Bragg reflections from FMCWR signals that reflect from the reflecting reference. Features of the reflecting reference can be configured to reflect the FMCWR 105 frequency (e.g., about 125-129 GHz) but not the gyrotron 102 frequency (e.g., about 95-105 GHZ). In this way, the reflecting reference can create a frequency peak fixed at a particular frequency, and the main signal generated by the FMCWR 105 would create peaks increasing in frequency with increasing distance from the reflecting reference. The difference between the two peaks can represent the standoff distance (Dst_{SO}).

In some embodiments, a reflecting reference can include features associated with the wall thickness of the end of launcher 129, 229. Part of the reflected signals from the FMCWR 105 would first hit the bottom 152 of the borehole 148, bounce back toward the reflecting reference, and hit the reflecting reference (instead of the waveguide opening and traveling back up to the surface), reflect from the reflecting reference back to the bottom 152 of the borehole 148 again, and finally back up through the waveguide 127. In this way, the signals from the FMCWR 105 travel down the waveguide 127 to the bottom 152 of the borehole 148>reflect back up from the bottom 152 toward the reflecting reference>reflect from the reflecting reference back down toward the bottom 152>reflect from the bottom 152>and back up into the waveguide 127. As such, a second beat frequency peak would be created at higher frequency than the main signal from the FMCWR 105 to the bottom 152 of the borehole 148 and back up through the waveguide 127 toward the receiver portion 105B of the FMCWR 105.

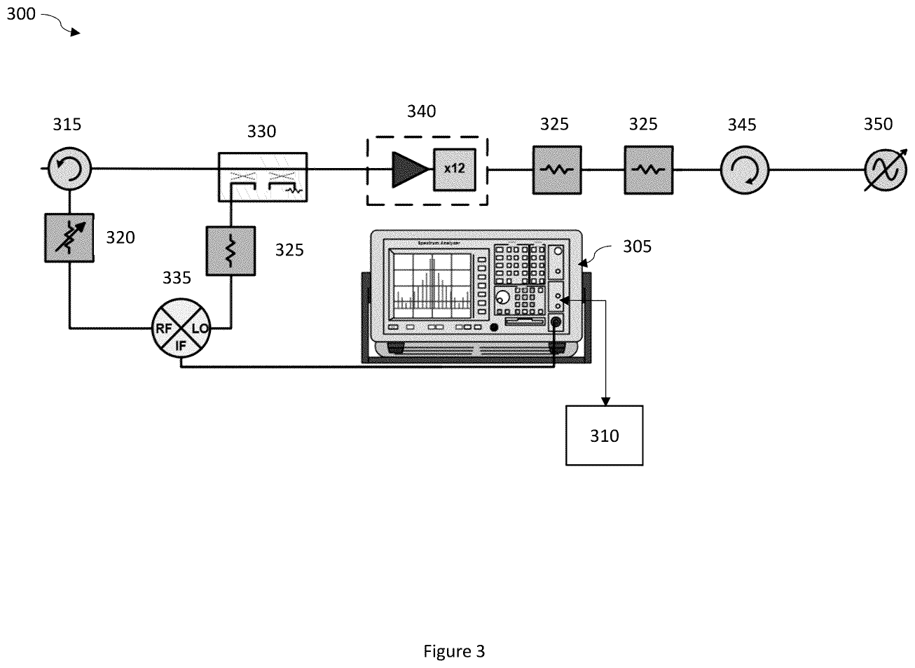

FIG. 3 illustrates a block diagram of an experimental circuit design 300 for a FMCWR configured to determine borehole depth and standoff distance as described herein. In circuit 300, the signal output of a frequency analyzer 305 is collected at a computing device 310. The circuit 300 includes a circulator 315 which can separate signals and act as a diplexer of the transmission and receiving signal, a variable attenuator 320, an attenuator 325, a directional coupler 330, an RF mixer 335, a frequency multiplier and amplifier chain 340, an isolator 345, and a voltage tuned source 350.

Distance ranging determinations can be determined using reflected radar signals. The reflected or echo signal received at the detector or receiver portion 105B of the FMCWR 105 is delayed and measured as beat frequency difference between the transmitted and reflected signals. The range which represents the distance between the source of the radar signal to the bottom 153 of the borehole 152 for triangular waves is given in the following formula:

$$Range = string length = \frac{{cf}_{B}}{4 {f}_{m} Δ f}$$

$$where Δ f = sweeping bandwidth = 4 GHz ,$$

$${f}_{m} = modulator frequency \approx 1 kHz .$$

$${f}_{B} = beat frequency measured by spectrum analyzer$$

$$c = speed of light$$

To calculate the range, the beat frequency can be measured by the spectrum analyzer 305 based on the formula above. The theoretical resolution of a FMCW radar, can be defined by the formula below.

$$Resolution = \frac{c}{2 Δ f} where Δ f = sweeping bandwidth = 4 GHz$$

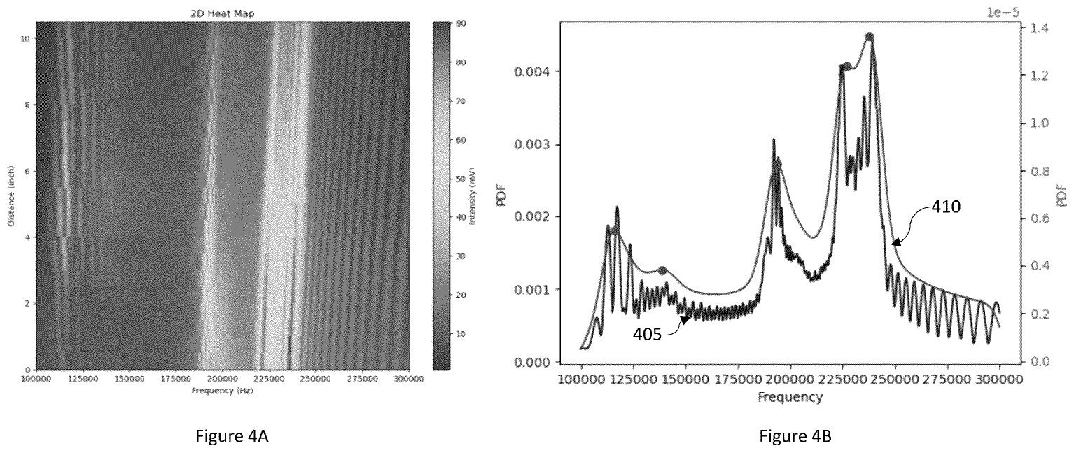

With a sweeping bandwidth of 4 GHz, the resolution of the FMCWR 105 would be approximately ±0.74 inches. Based on results collected from 21 FMCW radar experiments using a 90.5 to 95.8 GHz FMCW radar operating in a rectangular to circular mode transition along with a scalar horn and corrugated taper, adaptation of the FMCW radar signals to the specific waveguide and transmission mode were able to covert the transmitted signal effectively to HE11 mode. By utilizing the appropriate FMCW radar settings and analysis techniques, the FMCW radar was able to achieve resolution of ±0.55 inches in experiments in which a basalt paver target is positioned and moved at 5-inch intervals from 0 to 21 inches standoff as measured from a launcher at the end of a 60 foot long waveguide. Plots of experimental results from these FMCW radar experiments are shown in FIGS. 4A and 4B, for which distance determinations were made using the circuit diagram 300 as an experimental model associated with portions of system 100.

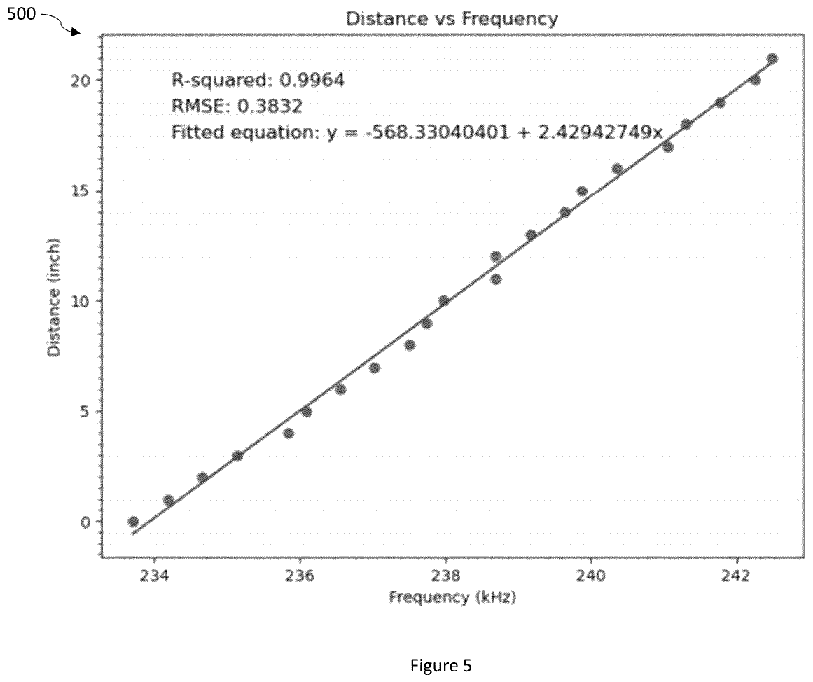

FIG. 4A illustrates a heatmap plot generated by combining all the amplitude vs beat frequency plots at all locations of the measurements from the spectrum analyzer 305 with the color map showing the amplitude as the intensity of the signal at the particular distance and frequency. FIG. 4B illustrates a plot of amplitude vs beat frequency spectrum from the spectrum analyzer 305 of the 60 FT experiment with the basalt paver at 9-inch standoff. The plot line 405 illustrates recorded raw data along the left Y-axis as a Poisson distribution function (PDF) vs frequency on the X-axis, while the plot line 410 illustrates a smoothed kernel density estimation with a bandwidth of 0.075 as shown along the right Y-axis. The location of the peaks can be determined using the find_peak function in the Python Scipy package. FIG. 5 illustrates a plot 500 of distance vs. peak beat frequency plot for the first 60 FT FMCW radar experiment. The circular points represent the frequency measured with paver at 0 to 21 inches standoff relative to the end of launcher in 0.5-inch increments.

To measure the standoff distance (Dst_{SO}) between the end of the launcher to the bottom 153 of the borehole 152, the FMCWR 105 can be utilized at frequencies between about 125-129 GHz. There are two potential methods to acquire standoff distance data using FMCW radar techniques. The first method is to have a reflecting reference at or in proximity of the launcher 129 that can include features such as an iris, a flange portion, corrugation features, or similar wall thickness features at a terminal end of the waveguide 127, such that part of the reflected FMCW radar signal would be reflected again by the launcher wall or flange-shaped element at the launcher 129, before transmitting back through the waveguide 127. As such, a second beat frequency peak would be created at higher frequency than the peak from the FMCW signal travelling from the FMCWR 105, such as the transmitting portion 105A to the bottom 152 of the borehole 148 and back to the FMCWR 105, such as the receiver portion 105B of the FMCWR 105.

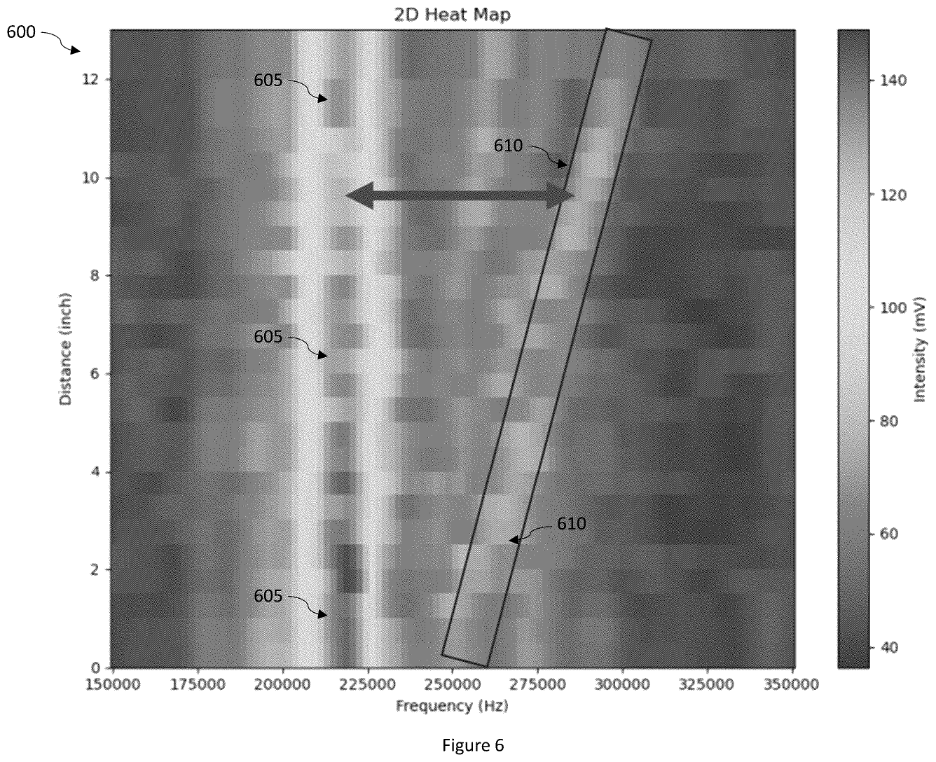

In some embodiments, the reflecting reference can create a beat frequency peak at lower frequency than the main FMCW signal peak. An example of this technique is illustrated in the heatmap plot 600 of FIG. 6 in which experimental data was collected using a FMCWR 105 operating at about 90-95 GHz. The results shown in the plot 600 of FIG. 6 were generated by combining all amplitude vs beat frequency plots at each location of the spectrum analyzer 305. The heatmap plot 600 illustrates the amplitude as a function of the intensity of the signal at the particular distance and frequency.

As seen in the heatmap plot 600 of FIG. 6, there is a vertical trend 605 originating from the reflection of the FMCW radar signal (over 70%) from the off-frequency diamond window. Additionally, the box 610 illustrates therein a trend of increasing frequency with increasing distance. The trend shown in the box 610 is indicative of the signal that passes through the diamond window 120 twice and is reflected off rock at the bottom 152 of the borehole 148, resulting in a total loss of 91% round trip. The standoff distance (Dst_{SO}) can then be determined by comparing frequency values between the trend shown in box 610 and the vertical trend 605.

The standoff distance (Dst_{SO}) can also be determined using acoustic processing techniques of acoustic signal pressures. In some embodiments, the acoustic processing techniques can be used in addition to or separately from the FMCWR signal processing techniques described earlier. The acoustic processing techniques described herein utilize an acoustic pressure signal that can be provided within the gas that flows inside the waveguide 127, such as an acoustic pressure signal provided via the SPU 136 shown and described in relation to FIG. 1. The acoustic pressure signal can travel through the gas and can reflect due to impedance changes at the bottom 152 of the borehole 148. By recording the reflected pressure signals using a suitable sensor, such as sensor 125, the distance from the sensor 135 to reflective elements such as a reflecting reference of the waveguide 127 and/or the bottom 152 of the borehole 148.

The acoustic impedance for air inside the waveguide 127 is inversely proportional to the cross-sectional area of the waveguide 127 when the wavelength of the acoustic waves passing through the waveguide 127 are greater than a diameter of the waveguide 127. When the acoustic pressure signal exits the terminal end of the waveguide 127 there will be an impedance change causing a reflection of the acoustic pressure signal. The acoustic pressure signal continues to the bottom 152 of the borehole 148 and can reflect off that impedance change. The reflected signal moves back up through the waveguide 127 where it can be detected at sensor 135. The reflection coefficient between two sections of waveguide 127 with different cross-sectional areas can be calculated as shown below, where A represents the cross-sectional area of respective sections 1 and 2 of the waveguide 127.

$$R = \frac{{A}_{1} - {A}_{2}}{{A}_{2} + {A}_{1}}$$

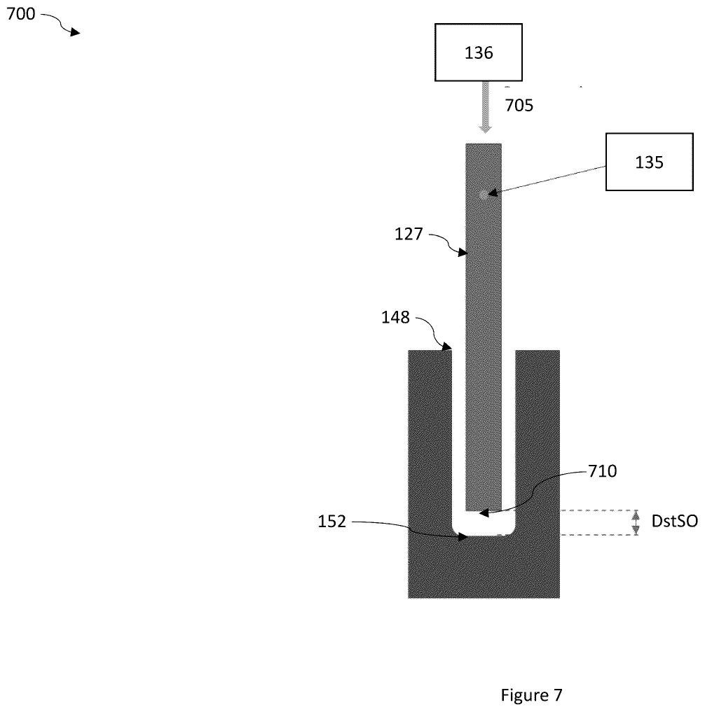

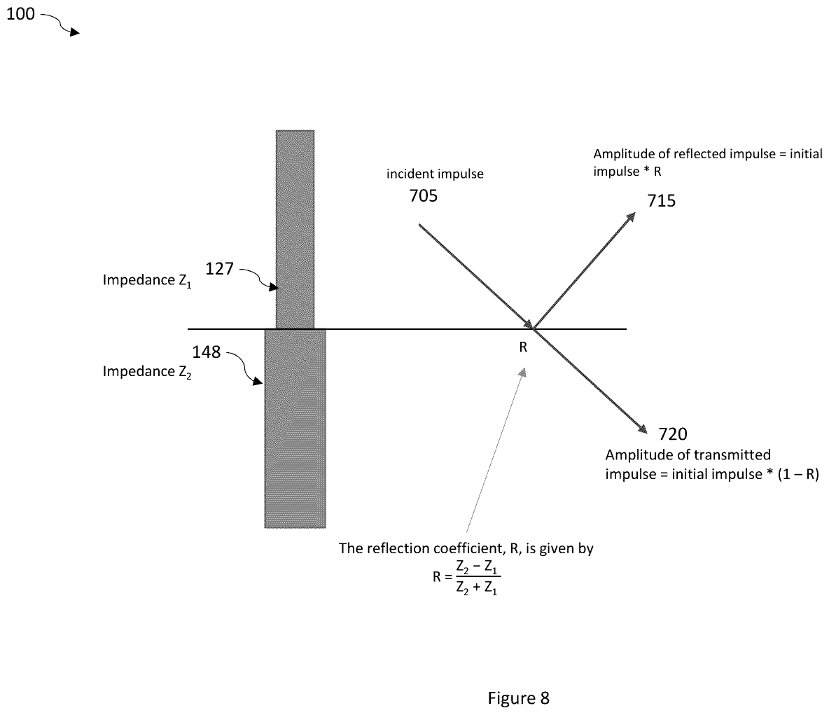

As shown in FIG. 7 and with reference to FIG. 1, a SPU 136 can supply an acoustic pressure signal 705 into the waveguide 127 extending into the borehole 148. The waveguide 127 can be configured with one or more sensors, such as pressure sensor 135. The acoustic pressure signal 705 can experience an impedance change at the terminal end 710 of the waveguide 127 as the acoustic pressure signal travels toward the bottom 152 of the borehole 148. As shown in FIG. 8, responsive to the acoustic pressure signal 705 passing through the end of the waveguide 127 and into the free space within the borehole 148, an impedance change can occur. A first impedance, Z₁, can be associated with the signal 705 within the waveguide 127 and a second impedance, Z₂, can be associated with the signal 705 as it exits the terminal end of the waveguide 705 and enters the free space within the borehole 148. An amplitude of the reflected impulse 715 can be determined as a function of the initial impulse 705 and a reflection coefficient, R, measured at the interface between Z₁ and Z₂. The reflection coefficient R can be determined as:

$$R = \frac{{Z}_{2} - {Z}_{1}}{{Z}_{2} + {Z}_{1}}$$

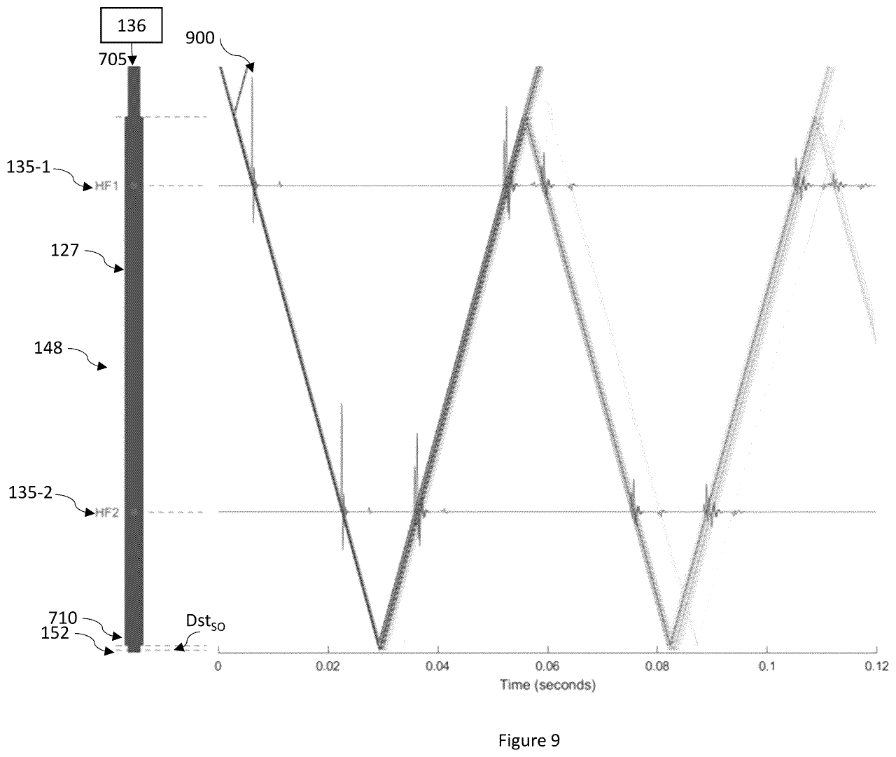

An amplitude of the transmitted impulse 720 can be determined as a function of the initial impulse 705 and (1−R) as shown in FIG. 8. FIG. 9 illustrates a plot 900 of a measured wavefield resulting from providing acoustic pressure signals 705 from the terminal end 710 of the waveguide 127 to the bottom 152 of the borehole 148 measured by high frequency sensors 135. Processing of the acoustic pressure signals it is possible to determine a distance from the sensors 135-1 and 135-2 to any impedance change in the system.

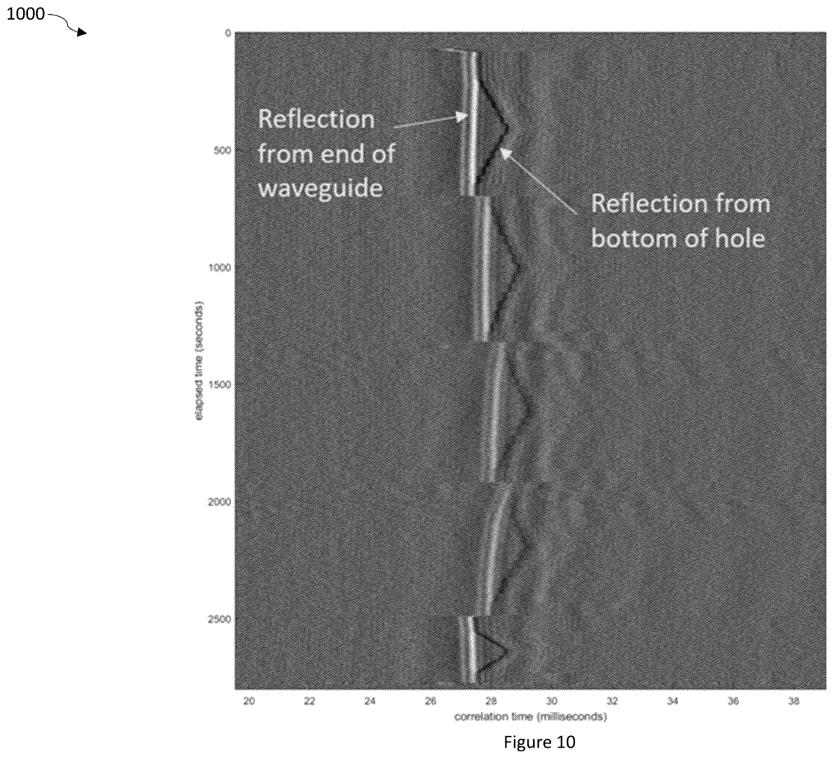

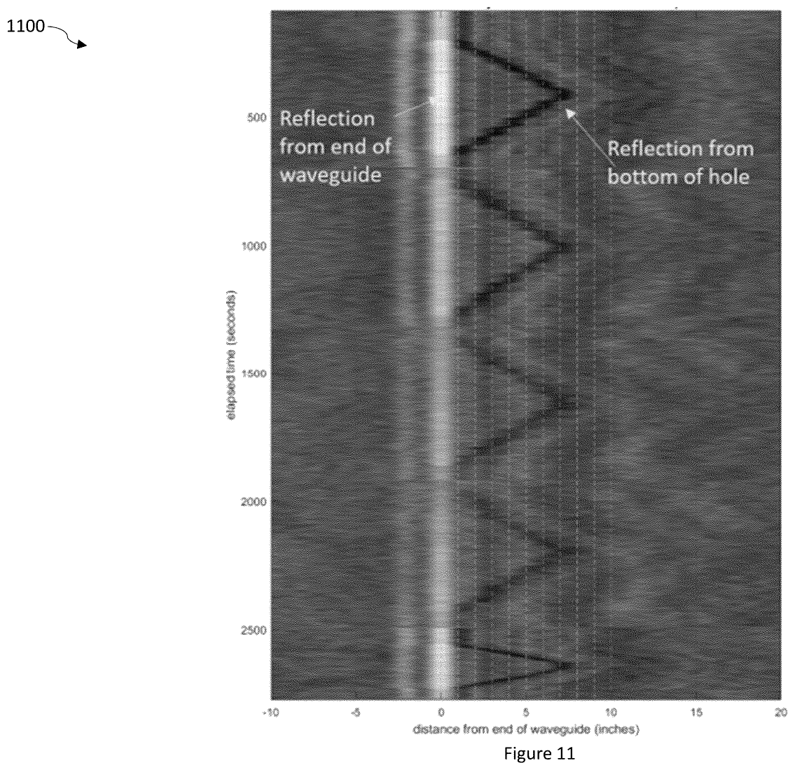

To further demonstrate the acoustic signal processing described above, experimental tests were carried out using a waveguide setup corresponding to system 100 of FIG. 1. Data from the high frequency sensors 135 was acquired and processed as the standoff distance (Dst_{SO}) was adjusted by moving the waveguide section 127 into or out of the borehole 148. The amount of time taken for the reflected energy to travel from the sensor 135 and back again can be determined. FIG. 10 illustrates a plot of correlation time (X-axis) as a function of elapsed time (Y-axis). The calculated times can be converted to distance by determining the velocity of the acoustic pressure signal 705 travelling in the waveguide 127. This velocity depends on the waveguide geometry and the temperature of the gas through which the acoustic pressure signal 705 propagates. When this correction is applied the reflecting elements, e.g., the terminal end 710 of the waveguide 127 or the bottom 152 of the borehole 148, can be imaged in terms of distance as shown in FIG. 11. As seen in the plot 1100, the reflection from the terminal end 710 of the waveguide 127 can be identified, along with the reflection from the bottom 152 of the hole 148. Distance can be determined from the use of acoustic pressure signals using tapped delay filter line estimation, frequency modulated continuous wave acoustic processing, and/or correlation and modeling techniques.

The improved system and methods described herein addresses the technical problem of determining a standoff distance between an end of a waveguide and a bottom of a borehole in which the waveguide is located. The standoff distance can be monitored during drilling operations using the same waveguide performing MMWD in order to perform the operation efficiently, maintain drilling equipment and waveguides in operable condition and to avoid damage to the waveguides and/or borehole due to accidental contact. Advantageously, the system and methods herein permit simultaneous MMWD operation and standoff distance measurement without requiring drilling operations to be halted so that standoff distances can be determined. The systems and methods herein enable the use of FMCW radar and acoustic signal measurement within the same waveguide used for MMWD. This can provide more accurate distance measurements that conventional drill string sensors and can reduce downtime of drilling operations to perform distance measurements. As a result, deeper deposits of natural and thermal resources can be accessed more efficiently than using conventional drilling apparatus and methods.

FIG. 12 is a block diagram 1200 of a computing system 1210 suitable for use in implementing the computerized components described herein, such as computing devices 109, 111, or 116 shown in system 100 of FIG. 1. In broad overview, the computing system 1210 includes at least one processor 1250 for performing actions in accordance with instructions, and one or more memory devices 1260 and/or 1270 for storing instructions and data. The illustrated example computing system 1210 includes one or more processors 1250 in communication, via a bus 1215, with memory 1270 and with at least one network interface controller 1220 with a network interface 1225 for connecting to external devices 1230. The one or more processors 1250 are also in communication, via the bus 1215, with each other and with any I/O devices at one or more I/O interfaces 1240, and any other devices 1280. The processor 1250 illustrated incorporates, or is directly connected to, cache memory 1260. Generally, a processor will execute instructions received from memory. In some embodiments, the computing system 1210 can be configured within a cloud computing environment, a virtual or containerized computing environment, and/or a web-based microservices environment.

In more detail, the processor 1250 can be any logic circuitry that processes instructions, e.g., instructions fetched from the memory 1270 or cache 1260. In many embodiments, the processor 1250 is an embedded processor, a microprocessor unit or special purpose processor. The computing system 1210 can be based on any processor, e.g., suitable digital signal processor (DSP), or set of processors, capable of operating as described herein. In some embodiments, the processor 1250 can be a single core or multi-core processor. In some embodiments, the processor 1250 can be composed of multiple processors.

The memory 1270 can be any device suitable for storing computer readable data. The memory 1270 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid-state memory), magnetic disks, and magneto optical disks. A computing device 1210 can have any number of memory devices 1270.

The cache memory 1260 is generally a form of high-speed computer memory placed in close proximity to the processor 1250 for fast read/write times. In some implementations, the cache memory 1260 is part of, or on the same chip as, the processor 1250.

The network interface controller 1220 manages data exchanges via the network interface 1225. The network interface controller 1220 handles the physical, media access control, and data link layers of the Open Systems Interconnect (OSI) model for network communication. In some implementations, some of the network interface controller's tasks are handled by the processor 1250. In some implementations, the network interface controller 1220 is part of the processor 1250. In some implementations, a computing device 1210 has multiple network interface controllers 1220. In some implementations, the network interface 1225 is a connection point for a physical network link, e.g., an RJ 45 connector. In some implementations, the network interface controller 1220 supports wireless network connections and an interface port 1225 is a wireless Bluetooth transceiver. Generally, a computing device 1210 exchanges data with other network devices 1230, such as computing device 1230, via physical or wireless links to a network interface 1225. In some implementations, the network interface controller 1220 implements a network protocol such as LTE, TCP/IP Ethernet, IEEE 802.11, IEEE 802.16, Bluetooth, or the like.

The other computing devices 1230 are connected to the computing device 1210 via a network interface port 1225. The other computing device 1230 can be a peer computing device, a network device, a server, or any other computing device with network functionality. In some embodiments, the computing device 1230 can be a network device such as a hub, a bridge, a switch, or a router, connecting the computing device 1210 to a data network such as the Internet.

In some uses, the I/O interface 1240 supports an input device and/or an output device (not shown). In some uses, the input device and the output device are integrated into the same hardware, e.g., as in a touch screen. In some uses, such as in a server context, there is no I/O interface 1240 or the I/O interface 1240 is not used. In some uses, additional other components 1280 are in communication with the computer system 1210, e.g., external devices connected via a universal serial bus (USB).

The other devices 1280 can include an I/O interface 1240, external serial device ports, and any additional co-processors. For example, a computing system 1210 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 1210, e.g., a touch screen on a tablet device. In some implementations, a computing device 1210 includes an additional device 1280 such as a co-processor, e.g., a math co-processor that can assist the processor 1250 with high precision or complex calculations.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving, by a data processor, first data characterizing a first radar signal reflected at a first frequency from a bottom of a borehole;
receiving, by the data processor, second data characterizing a second radar signal reflected from a waveguide within the borehole;
determining, by the data processor, a distance between the waveguide and the bottom of the borehole based on a time of flight difference between the first radar signal and the second radar signal; and
providing, by the data processor, the distance.

2. The method of claim 1, wherein the first radar signal is reflected responsive to transmitting a third radar signal into the waveguide from a FMCW radar coupled to the waveguide.

3. The method of claim 2, wherein the third radar signal is transmitted coincident with an electromagnetic wave transmitted into the waveguide by a gyrotron coupled to the waveguide.

4. The method of claim 3, wherein the electromagnetic wave is transmitted into the waveguide in HE11 transmission mode.

5. The method of claim 2, wherein the second radar signal is measured as a beat frequency difference between the third radar signal and the second radar signal.

6. The method of claim 1, wherein the distance is measured between the bottom of the borehole and a terminal end of the waveguide.

7. The method of claim 1, wherein the distance is a standoff distance.

8. A method comprising:
receiving, by a data processor, first data characterizing a first acoustic signal corresponding to a first impedance change reflected from a waveguide inserted into a borehole;
receiving, by the data processor, second data characterizing a second acoustic signal corresponding to a second impedance change reflected from a bottom of the borehole;
determining, based on the data processor, a distance between the waveguide and the bottom of the borehole based on a time of flight difference between the first acoustic signal and the second acoustic signal; and
providing, by the data processor, the distance.

9. The method of claim 8, wherein the first impedance change is reflected responsive to transmitting an acoustic pressure signal into the waveguide via a gas supply unit coupled to the waveguide, the gas supply unit configured to supply the acoustic pressure signal into the waveguide.

10. The method of claim 8, wherein the first data and the second data are received by at least one pressure sensor positioned on the waveguide and communicably coupled to the data processor.

11. The method of claim 10, wherein the at least one pressure sensor includes a high frequency pressure sensor.

12. The method of claim 8, wherein determining the distance further comprises determining a first velocity of the first acoustic signal and a second velocity of the second acoustic signal.

13. The method of claim 8, wherein the distance is determined using at least one of tapped delay filter line estimation techniques or frequency modulated continuous wave processing techniques.

14. A system comprising:
a waveguide positioned within a borehole;
a gyrotron coupled to the waveguide and configured to transmit electromagnetic waves into the borehole via the waveguide;
a radar source coupled to the waveguide and configured to transmit radar signals into the borehole via the waveguide, and
at least one computing device communicably coupled to the radar source, the at least one computing device including a data processor and a memory storing non-transitory instructions, which when executed by the data processor, cause the data processor to perform operations comprising
receiving first data characterizing a first radar signal reflected at a first frequency from a bottom of the borehole;
receiving second data characterizing a second radar signal reflected from the waveguide within the borehole;
determining a distance between the waveguide and the bottom of the borehole based on a time of flight difference between the first radar signal and the second radar signal; and
providing, by the data processor, the distance.

15. The system of claim 14, wherein the radar source is a frequency modulated continuous wave radar.

16. The system of claim 15, wherein the radar source is coupled to the waveguide by at least one of a transmission mode converter or a diffraction grating mirror configured to maintain provision of the transmitted radar signals as frequency modulated continuous wave radar signals.

17. The system of claim 14, wherein the first radar signal is reflected responsive to the radar source transmitting a third radar signal into the waveguide.

18. The system of claim 17, wherein the third radar signal is transmitted coincident with an electromagnetic wave transmitted into the waveguide by the gyrotron.

19. The system of claim 18, wherein the electromagnetic wave is transmitted into the waveguide in HE11 transmission mode.

20. The system of claim 19, wherein the waveguide includes a plurality of corrugation features arranged on an inner surface of the waveguide, the plurality of corrugation features configured to maintain transmission of the electromagnetic wave through the waveguide and into the borehole in the HE11 transmission mode.

21. The system of claim 17, wherein the second radar signal is measured as a beat frequency difference between the third radar signal and the second radar signal.

22. A system comprising:
a waveguide positioned within a borehole and including at least one pressure sensor arranged on the waveguide;
a gyrotron coupled to the waveguide and configured to transmit electromagnetic waves into the borehole via the waveguide;
a gas supply unit coupled to the waveguide and configured to transmit acoustic signals via a gas into the borehole via the waveguide, and
at least one computing device communicably coupled to the at least one pressure sensor and the gas supply unit, the at least one computing device including a data processor and a memory storing non-transitory instructions, which when executed by the data processor, cause the data processor to perform operations comprising
receiving first data characterizing a first acoustic signal corresponding to a first impedance change reflected from a waveguide inserted into a borehole;
receiving second data characterizing a second acoustic signal corresponding to a second impedance change reflected from a bottom of the borehole;
determining a distance between the waveguide and the bottom of the borehole based on a time of flight difference between the first acoustic signal and the second acoustic signal; and
providing the distance.

23. The system of claim 22, wherein the first impedance change is reflected responsive to transmitting an acoustic pressure signal into the waveguide via the gas supply unit.

24. The system of claim 22, wherein the first data and the second data are received by the at least one pressure sensor.

25. The system of claim 22, wherein the at least one pressure sensor includes a high frequency pressure sensor.

26. The system of claim 22, wherein determining the distance further comprises determining a first velocity of the first acoustic signal and a second velocity of the second acoustic signal.

27. The system of claim 22, wherein the distance is determined using at least one of tapped delay filter line estimation techniques or frequency modulated continuous wave processing techniques.
